(19) United States
(12) Patent Application Publication
(10) Pub. No.: US 2004/0130081 A1
(43) Pub. Date: Jul. 8, 2004

(54) PIEZOELECTRIC MATERIAL TO DAMP VIBRATIONS OF AN INSTRUMENT PANEL AND/OR A STEERING COLUMN

(76) Inventors: David A. Hein, Sterling Heights, MI (US); Robert J. Adams, Ypsilanti, MI (US)

Correspondence Address: ARTZ & ARTZ, P.C., 28333 TELEGRAPH RD., SUITE 250, SOUTHFIELD, MI, 48034, US

(21) Appl. No.: 10/248,288

(22) Filed: Jan. 6, 2003

(51) Int. Cl. F16M 5/00

(52) U.S. Cl. 267/140.14; 280/124.108

(57) ABSTRACT

A method for reducing vibration in an instrument panel structure is achieved by introducing one or more piezoelectric actuator and sensor assemblies between various structures contained within the instrument panel structure. The assembly has a sensor component that senses vibrations between the structures and an actuator component that is activated to produce a reverse sine pulse that dampens the vibrations. The assembly also has an electronic control module, located integrally or as a separate component, electrically to the sensor and actuator for precisely controlling the actuation of the actuator. In alternative embodiments, multiple assemblies may be coupled to a single electronic control module for achieving total system vibration control.

### BACKGROUND OF INVENTION

The present invention relates generally to vibration dampening in automotive applications and more particularly to dampening vibrations in instrument panels and steering columns using piezoelectric material.

A factor in the quality perception in automobiles is the stiffness or lack of vibration in automotive components such as the steering column and instrument panel. The stiffness of these components is measured by the frequency of the first vibration mode and typically is in the range of 30 to 40 Hertz for typical vehicles and greater than 50 Hertz for best in class vehicles.

Various methods have been proposed to improve vibration properties of these components. For example, one proposed method is to increase the stiffness of the cross car beam used to attach the instrument panel and steering column and various other components within the automobile. However, increasing the stiffness of the car beam alone does not generally achieve the levels of dampness required. Further, increasing the stiffness generally increases mass of the car beam, which leads to decreased fuel economy, increased raw material costs, and potentially leads to increased manufacturing costs associated with assembly and formation.

Another proposed method to improve vehicle vibration requirements is to add various and attachments to the cross car beam, instrument panel, and/or steering column designed to decrease the vibrations within these components. However, this leads to increased manufacturing costs associated with the components. Also, the vehicle assembly process typically limits the number, location, and type of these various vehicle body attachments.

It is therefore an object of the present invention to dampen vibrations in the steering column and instrument panel in a cost effective and efficient way without adding significant mass and or complexity to the components.

### SUMMARY OF INVENTION

In accordance with the above objects, the present invention proposes a new smart system, or active system, for sensing vibrations within the instrument panel and/or steering column. The system will then counteract the vibrations through a reverse sine force actuated on the instrument panel and/or steering column structure. The mechanical force will counteract the vibrations and prevent the development of harmonic vibrations within the structures.

A method to achieve active vibration suppression is to utilize piezoelectric sensors and actuators coupled within the structure. The sensors will be utilized to sense the vibrations and provide information to an electronic control module. The control module will then activate the piezoelectric actuators to produce a reverse sine pulse to counteract the vibration. The sensor and actuator could be two separate units or one integrated component. Preferably, the integrated sensor and actuator unit is self-powered.

Other objects and advantages of the present invention will become apparent upon considering the following detailed description and appended claims, and upon reference to the accompanying drawings.

### BRIEF DESCRIPTION OF DRAWINGS

FIG. 1 illustrates a perspective view an cross car beam coupled to a vehicle support structure and to a steering column support structure according to one preferred embodiment of the present invention;

FIG. 2 is a close-up view of the coupling of the cross car beam to the steering column of FIG. 1;

FIG. 3 is a close-up view of the coupling of the cross car beam to the vehicle body of FIG. 1;

FIG. 4 is a top view of one of the integrated piezoelectric sensor and actuator component of FIG. 3; and

FIG. 5 is a side view and partial section view of FIG. 4.

### DETAILED DESCRIPTION

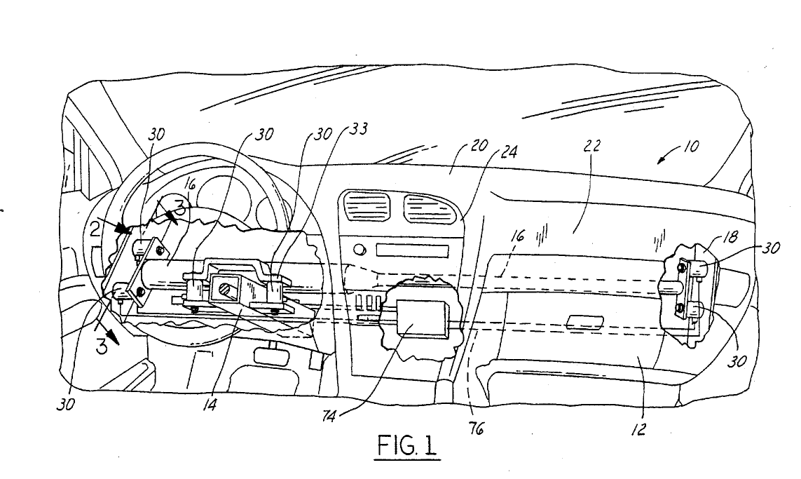

Referring now to FIG. 1, an instrument panel structure is generally indicated by reference numeral 10. The structure 10 includes an instrument panel subassembly 12 and steering column 14 attached to and supported by a cross car beam 16. The cross car beam 16 is also attached at each respective end to the vehicle body 18.

The instrument panel subassembly 12 can have various components, including for example, a top cover 20, a front panel 22, and a center stack 24. Top panel 20 is typically configured to attach to cross-car beam 16 and front panel 22 to enclose the myriad of electronic devices housed within the instrument panel subassembly 10. Center stack 24 is configured to meet with the top panel 20 and front panel 22 in order to provide a unified instrument panel appearance.

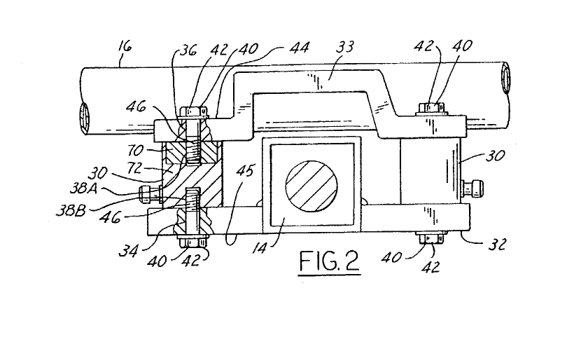

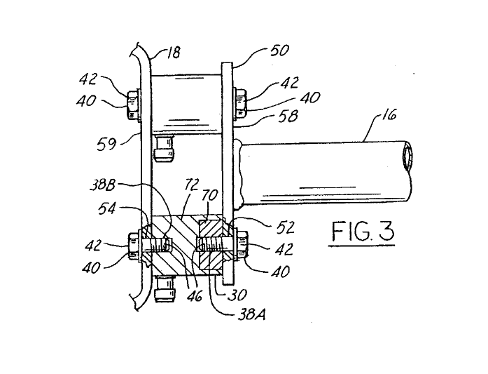

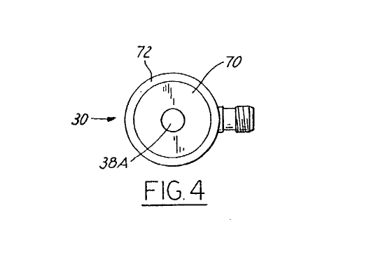

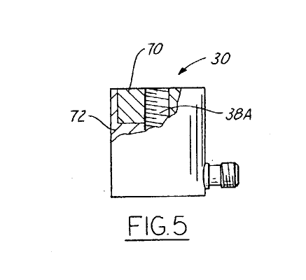

Also shown coupled within various portions of the instrument panel structure 10 are one or more piezoelectric actuator and sensor assemblies 30. These assemblies 30 function to effectively minimize vibration within the instrument panel structure 10, especially at mounting locations between various components on the structure 10. FIGS. 2 and 3 below illustrate two preferred locations for mounting the assemblies 30 within the instrument panel structure 10. FIGS. 4 and 5 show a close-up view of one preferred piezoelectric actuator and sensor assembly 30.

Referring now to FIG. 2, a close-up view of the coupling between the cross car beam 16 and steering column 14 is illustrated. The steering column 14 is shown having a steering column mounting bracket 32. The bracket 32 may be integrally formed to the steering column 14 or rigidly attached in a separate step. A steering column support bracket 33 is rigidly attached to the cross car beam 16 and is used to support the steering column 14.

The bracket 32 has at least two holes 34 located circumferentially around the steering column 14 that roughly correspond to holes 36 located on the steering column support structure 33. A piezoelectric actuator and sensor assembly 30 having an upper and lower inlet region 38A, 38B is secured between to brackets 32, 33 by introducing a respective screw 40, or bolt, through each of the corresponding holes 34 36 and into the respective inlet regions 38A, 38B. As shown in FIG. 2, a first screw 42 is introduced through the hole 36 of the mounting bracket 33 and into the upper inlet region 38A to secure the assembly 30 to the support bracket 32 such that the head regions 42 of the screws 40 are closely coupled with an upper surface 44 of the steering column support bracket 33. A second screw 40 is introduced from beneath the mounting bracket 32 through hole 34 and into the lower inlet region 38B of the assembly 30 to secure the assembly 30 to the mounting bracket 32 such that the head region 42 is closely coupled to a lower surface of the mounting bracket 32. As one of ordinary skill appreciates, the diameter size of the holes 34, 36 and inlet regions 38A, 38B is designed to closely correspond the outer diameter of the bolt portion 46 of each respective screw 40.

As one of ordinary skill also appreciates, the method of attaching the assembly 30 to the respective brackets 32, 33 may be accomplished in a wide variety of manners other than that shown in FIG. 2 and are specifically contemplated by the present invention. For example, the sensor and actuator assembly may be coupled to both respective brackets 32, 33 using a single screw 40 or bolt by modifying the inlet regions 38A, 38B to extend entirely through a portion of the assembly.

Referring now to FIG. 3, a close-up view of the coupling of the cross car beam 16 to the vehicle body 18 is shown. The cross car beam 16 has a cross car beam mounting bracket 50 having at plurality of holes 52. The vehicle body 18 also has a corresponding plurality of holes 54. Another piezoelectric actuator and sensor assembly 30 having inlet regions 38A, 38B is secured between the vehicle body 18 and cross car beam 16 in at least one set of corresponding plurality of holes 52, 54 by introducing a pair of respective screws 40 or bolt through each of the corresponding holes 52, 54 and into the respective inlet region 38A, 38B such that the head portion 42 of one of the screws 40 is closely coupled with an inner surface 58 of the bracket 50 and the head portion 42 of the other screw 40 or bolt is closely coupled with an outer surface 59 of the body 18. As one of ordinary skill appreciates, the diameter size of the holes 52, 54 and inlet regions 38A, 38B is designed to closely correspond the outer diameter of the bolt portion 46 of each respective screw 40 or bolt.

Of course, in alternative preferred embodiments (not shown), the mounting bracket 33 used to couple the steering column 14 to the cross car beam 16 could be formed integrally or coupled directly to the cross car beam 16, and not to the steering column 14 as shown in FIG. 2, and still fall within the spirit of the present invention. Similarly, the mounting bracket could also be formed or coupled to the vehicle body 18, and not the cross car beam, as shown in FIG. 3.

Each piezoelectric actuator and sensor assembly 30, as best shown in FIGS. 4 and 5, consists of a sensor 70 and actuator 72 contained within a main portion 78 of the assembly 30. The sensor 70 and actuator 72 are electrically coupled with a control module 74 via a wire 76 or similar connecting device. The sensor 70 and actuator 72 are preferably made of piezoelectric materials such as fine grain ceramic material that enables low voltage actuators 72 having high strain energy density and high reliability. One preferred manufacturer of low voltage, high force piezoelectric sensor 70 and actuators 72 is TRS Ceramics of State College, PA, which manufactures the low voltage actuators, large stroke actuators, and co-fired actuators that may be used in the assemblies 30.

In operation, the sensor 70 senses vibrations created within the instrument panel structure 10 during vehicle operation. An electrical signal is generated from the sensor 70 corresponding to the amplitude and frequency of the sensed vibration. The control module 74 receives the electronic signal from the sensor 70 through wire 76, interprets the signal, and generates a response signal through wire 76 to activate the actuator 72. The actuator 72 generates a reverse sine pulse force to counteract, or prevent, the vibration sensed by the sensor 30.

As one of ordinary skill can appreciate, the assemblies 30 could be electrically coupled with individual control modules 74 as shown in FIGS. 4 and 5. Alternatively, two or more of the assemblies 30 may be electrically coupled to a single electronic control module 74, thereby providing an integrated system for controlling vibration throughout the instrument panel structure 10.

Further, while the assemblies 30 are shown in their preferred mounting locations between the cross car beam 16 and either the steering column 14 or vehicle body 18 as shown in FIGS. 1-3, it is specifically contemplated that other mounting positions within the instrument panel structure 10 are possible and may be highly desirable based on the vehicle size and make. This includes but is not limited to mountings internal within the cross car beam 16, instrument panel subassembly 12, steering column 14, or vehicle body 18 and still fall within the spirit of the present invention.

Further, while the instrument panel assembly 10 is shown in a typical configuration including a cross car beam 16, it is specifically contemplated other methods of achieving the instrument panel structure are possible and may be highly desirable based on the vehicle size and make. This includes but is not limited to integrated plastic structural ducts, hybrid metal and plastic structures, or other structures for the support of the instrument panel 10 and still fall within the spirit of the present invention.

In addition, while not shown above, the assembly 30 could be self-powered, wherein the sensor 70 harvests energy from the sensed vibrations to provide energy to the actuator 72 to counteract the vibrations. Further, in other preferred embodiments, one component could act as both the sensor 70 and actuator 72.

In addition, while not shown above, the sensors 70 could be coupled directly to the corresponding wire 76. In this configuration, the electronic control module 74 would not be required.

In yet another preferred embodiment (not shown), the sensor 70 and actuator 72 could be formed as two separate units, as opposed to one assembly 30. In this embodiment, the sensor 70 and actuator 72 are electrically coupled via an electronic control module 74 as described above with regards to FIGS. 1-5. The electronic control module 74 can be formed integrally with the sensor 70, the actuator 72 or can function as a stand-alone unit. In addition, the actuator 72 is mounted similarly to the assembly 30 as described above in FIGS. 1-5, while the sensor 70 is mounted or otherwise located anywhere on the instrument panel structure 10 to sense vibrations.

The present invention thus describes a smart system, or active system, to sense vibrations in an instrument panel structure 10, including the steering column 14. The smart system will contract sensed vibrations through a mechanical reverse sine pulse actuated on the instrument panel structure 10. The mechanical force will counteract the vibrations or otherwise prevent harmonic vibrations within the instrument panel structure 10. This results in better perceived quality of the interior of a vehicle without the need for stiffer components or added attachments that lead to increased assembly complexity. Cost savings associated with decreased complexity, assembly, and stiffness are thus realized. In preferred embodiments as described above in FIGS. 1-3, first vibration mode measurements of greater than 50 Hertz may be achieved.

While the invention has been described in terms of preferred embodiments, it will be understood, of course, that the invention is not limited thereto since modifications may be made by those skilled in the art, particularly in light of the foregoing teachings.

1. A method for dampening vibration in a vehicle's instrument panel structure comprising:
coupling a piezoelectric sensor and actuator assembly between a first structure and a second structure within the instrument panel structure, said piezoelectric sensor and actuator assembly having a sensor and an actuator;
electrically coupling an electronic control module to said actuator and said sensor;
sensing a level of vibration with said sensor;
generating a first signal within said sensor as a function of said sensed level of vibration;
sending said first signal to said electronic control module;
processing said first signal within said electronic control module to generate a response signal
sending said response signal from said electronic control module to said actuator; and
activating said actuator as a function of said response signal to dampen said level of vibration.

2. The method of claim 1, wherein said first structure is selected from the group consisting of a cross car beam, an instrument panel subassembly, a steering column, and a vehicle body.

3. The method of claim 2, wherein said second structure is selected from the group consisting of said cross car beam, said instrument panel subassembly, said steering column, and said vehicle body.

4. The method of claim 1, wherein said electronic control module is formed integrally within said piezoelectric sensor and actuator assembly.

5. The method of claim 1 further comprising coupling at least one additional piezoelectric sensor and actuator assemblies between a first structure and a second structure within the instrument panel structure, each of said at least one additional piezoelectric sensor and actuator assemblies having a second sensor and a second actuator.

6. The method of claim 5 further comprising electrically coupling said second sensor and said second actuator of at least one of said at least one additional piezoelectric sensor and actuator assemblies to said electronic control module.

7. The method of claim 5 further comprising electrically coupling said second sensor and said second actuator of all of said at least one additional piezoelectric sensor and actuator assemblies to said electronic control module.

8. The method of claim 1, wherein sensing said level of vibration and activating said actuator comprises:
sensing a level of vibration with said sensor, said level of vibration having a first amplitude and a first frequency; and
activating said actuator as a function of said response signal to dampen said first amplitude and said first frequency.

9. The method of claim 8, wherein activating said actuator comprises generating a reverse sine pulse within said actuator to dampen said first amplitude and said first frequency.

10. The method of claim 1, wherein sensing said level of vibration and activating said actuator comprises:
sensing a level of vibration between said first structure and said second structure with said sensor, said level of vibration having a first amplitude; and
activating said actuator as a function of said response signal to dampen said first amplitude.

11. The method of claim 10, wherein activating said actuator comprises generating a reverse sine pulse within said actuator to dampen said first amplitude.

12. The method of claim 1, wherein sensing said level of vibration and activating said actuator comprises:
sensing a level of vibration between said first structure and said second structure with said sensor, said level of vibration having a first frequency; and
activating said actuator as a function of said response signal to dampen said first frequency.

13. The method of claim 12 wherein activating said actuator comprises generating a reverse sine pulse within said actuator to dampen said first frequency.

14. An instrument panel structure within a vehicle having improved vibrational dampening characteristics, the instrument panel structure having a first structure and a second structure, the improvement comprising:
a piezoelectric sensor and actuator assembly coupled between the first structure and the second structure, said piezoelectric sensor and actuator assembly having a sensor and an actuator, wherein said sensor is capable of detecting a level of vibration during operation of the vehicle and wherein said actuator is capable of being actuated to dampen said detected level of vibration; and
an electronic control module electrically coupled to said sensor and said actuator, said electronic control module used to interpret a signal generated by said sensor to control the actuation of said actuator, said signal being a function of said level of vibration.

15. The instrument panel structure of claim 14, wherein said electronic control module is integrally formed within said piezoelectric sensor and actuator assembly.

16. The instrument panel structure of claim 14 further comprising at least one additional piezoelectric actuator and sensor assembly coupled between said first structure and said second structure, said at least one additional piezoelectric actuator and sensor assembly having a second sensor and a second actuator, wherein said second sensor is capable of detecting a second level of vibration generated between the first structure and second structure during operation of the vehicle and wherein said second actuator is capable of dampening said second level of vibration.

17. The instrument panel structure of claim 16, wherein at least one of said at least one additional piezoelectric actuator and sensor assembly is electrically coupled to said electronic control module, wherein said electronic control module is used to control the actuation of said second actuator to dampen said second level of vibration as a function of said second detected level of vibration.

18. The instrument panel structure of claim 16, wherein all of said at least one additional piezoelectric actuator and sensor assembly is electrically coupled to said electronic control module, wherein said electronic control module is used to control the actuation of said second actuator to dampen said second level of vibration as a function of said second detected level of vibration.

19. The instrument panel of claim 14, wherein said piezoelectric sensor and actuator assembly is secured between the first structure and the second structure using a screw or a bolt.

20. The instrument panel of claim 14, wherein said actuator comprises a ceramic actuator.

21. An instrument panel structure within a vehicle having improved vibrational dampening characteristics, the instrument panel structure having a first structure and a second structure, the improvement comprising:
a vibration sensor located on or near the instrument panel; and
an actuator coupled between the first structure and the second structure,
wherein said sensor is capable of detecting a level of vibration generated during operation of the vehicle and wherein said actuator is capable of dampening said detected level of vibration.

22. The instrument panel structure of claim 21, further comprising an electronic control module electrically coupled to said sensor and said actuator, said electronic control module used to interpret a signal generated by said sensor to control the actuation of said actuator, said signal being a function of said level of vibration.

23. The instrument panel structure of claim 22, wherein said electronic control module is integrally formed within said sensor assembly.

24. The instrument panel structure of claim 22, wherein said electronic control module is integrally formed within said actuator assembly.

25. The instrument panel structure of claim 21 further comprising at least one additional sensor, wherein said second sensor is capable of detecting a second level of vibration during operation of the vehicle.

26. The instrument panel structure of claim 21 further comprising at least one additional actuator, wherein said second actuator is capable of being actuated to dampen said level of vibration of the vehicle.

27. The instrument panel structure of claim 26, wherein at least one of said at least one additional actuator is electrically coupled to said electronic control module, wherein said electronic control module is used to control the actuation of said second actuator to dampen said level of vibration.

28. The instrument panel of claim 21, wherein said sensor is coupled directly to said actuator to dampen said level of vibration.

29. The instrument panel of claim 21, wherein said sensor is a piezoelectric sensor.

30. The instrument panel of claim 21, wherein said actuator is a piezoelectric actuator.

31. The method of claim 21, wherein said first structure is selected from the group consisting of a cross car beam, an instrument panel subassembly, a steering column, and a vehicle body.

32. The method of claim 31, wherein said second structure is selected from the group consisting of said cross car beam, said instrument panel subassembly, said steering column, and said vehicle body.
